(19) United States
(12) Patent Application Publication
(10) Pub. No.: US 2024/0371021 A1
(43) Pub. Date: Nov. 7, 2024

(54) DETECTION OF IMAGE STRUCTURES VIA DIMENSIONALITY-REDUCING PROJECTIONS

(71) Applicant: Brainlab AG, Munich (DE)

(72) Inventors: Andreas BLUMHOFER, Munich (DE); Elise EMOND, Munich (DE); Mikhail STARTSEV, Munich (DE)

(21) Appl. No.: 18/038,195

(22) PCT Filed: Jan. 13, 2022
(86) PCT No.: PCT/EP2022/050669

§ 371 Date: May 22, 2023

(51) Int. Cl. G06T 7/70

(52) U.S. Cl. CPC G06T 7/70; G06T 2207/10081; G06T 2207/10088; G06T 2207/20081; G06T 2207/20084; G06T 2207/30012

(57) ABSTRACT

A system and related method for computer-implemented medical image processing. The method may comprise a step of receiving (S720) input data comprising a projection of a three-dimensional, 3D, or higher dimensional image volume generated by a medical imaging apparatus. The method may comprise processing (S740) the input data by using a trained machine learning model (M) to facilitate computing a location in the 3D volume of a structure of interest. The method may include outputting (S760) output data indicative of the said location.

### FIELD OF THE INVENTION

The present invention relates to a computer-implemented medical image processing method, a method of training a machine learning model for use in such a method, a method of generating training data for training a machine learning model, corresponding computer programs, a non-transitory program storage medium storing any one of such a program and a computer for executing any one of such a program, as well as a medical system comprising an electronic data storage device and the aforementioned computer.

### TECHNICAL BACKGROUND

Medical imaging is among the most important tool in the arsenal of modern medicine. According to a report by the Harvard Medical School (available online at https://www.health.harvard.edu/cancer/radiation-risk-from-medical-imaging) 80 million CT scans have been conducted in the United States, up from a mere 3 million in 1980.

Medical imaging allows in a non-invasive and painless manner to collect image information that represents internal anatomies, tissue, or organs within the patient to so support diagnosis and/or treatment. A host of medical imaging applications, not only CT or x-ray based, are at the clinician's disposal, including magnetic resonance imaging, emission type medical imaging such as SPECT and PET and others. Over the years, medical imaging has evolved and now generates high dimensional (“high-dim”) image data including 3D or 4D imagery.

Such high-dim image volumes are complex data conglomerates and navigating these may not be easy, in particular for the medical novice, but also for the more experienced user in stress situations such as in the trauma room for example. In particular, finding image structures that represent the region of interest at hand may not be a straight-forward matter. For example, for radiation treatment planning a precise localization in such high dimensional image data may not be straight forward but is all the more paramount to successfully force cancer into recession. Planning or real-time navigation based on such high-dim imagery may be called for in other application such as in medical interventions.

Various computational tools may be used to localize such structures. Recently machine learning has been used. However, machine learning, especially when consuming high dimensional data may require considerable amounts of memory space and/or CPU overheads which may be put some of these new ML-based computation methods out of reach for some or make them impractical in time-critical applications such as the said interventions where next to real-time results are called for.

There may therefore be a need for improved localization in high dimensional (at least 3D) imagery, in particular in the medical field.

Aspects of the present invention, examples and exemplary steps and their embodiments are disclosed in the following. Different exemplary features of the invention can be combined in accordance with the invention wherever technically expedient and feasible.

### EXEMPLARY SHORT DESCRIPTION OF THE INVENTION

In the following, a short description of the specific features of the present invention is given which shall not be understood to limit the invention only to the features or a combination of the features described in this section.

In the proposed method and system, rather than processing high dimensional imagery as is, the high dimensional imagery is first reduced dimensionally by projection operation to obtain lower dimensional projection(s). It is the projection(s) that are then fed into a trained machine learning model to compute therefrom, in a memory- and time conservative manner, a location of a structure of interest within the high dimensional volume. This allows using powerful machine learning models even on modest computer equipment or allows for lower memory consumption and higher throughput which may be beneficial, in particular in ever busy clinical environments for example.

### GENERAL DESCRIPTION OF THE INVENTION

In a first aspect there is provided a computer-implemented medical image processing method, comprising:—
a) receiving input data comprising at least one projection of an at least 3D image volume generated by a medical imaging apparatus;
b) processing the input data by using at least a trained machine learning model (M) to at least facilitate computing a location in the 3D volume of a structure of interest; and
c) outputting output data indicative of the said location.

The output location in the at least 3D image volume may include a point coordinate. a group of coordinates, a bounding box, a segmentation, etc. The projection has a spatial dimension such as 2D if the volume is 3D of higher dimensional. The projection is thus a lower dimensional representation of spatial information in the volume. The projection is preferably at least 2D.

In embodiments, the input data includes plural such projections at different projection geometries and the said processing includes back-projecting projection footprints of the structure, or respective locations thereof, in the plural projections as computed by the trained machine learning model. There may be at least one such projection footprint (or view) per projection.

Thus, the method may either compute the location based on machine learning (ML) end-to-end, or the ML-model may produce preliminary results (the locations of lower dimensional footprints in the lower dimensional projections as compared to the dimension of the image volume) which are then back-projected to find the location in the high-dim volume.

A single projection may be sufficient for the model to find the location in the 3D or higher dimensional volume. In particular contextual patient data (such as bio-characteristics, medical history, etc) may be used and co-processed with the single or more projections to boost ML performance.

The model may be of the artificial neural network type, such as convolution neural network in particular (CNN). Such CNN have been observed to produce good results in particular for processing spatial data such as image data of main interest herein.

In embodiments, the processing may include combining the back-projected locations of the projection footprints into the 3D location. The combining may include averaging, computing barycenters, triangulation, or fitting to a shape primitive model to obtain the location. The location may be defined as a well-defined point of the shape primitive such as its centre point, a corner point, ec. For example, an ellipse/ellipsoid, circle/sphere, etc may be used as such as shape primitive. The combining may include a consensus-based procedure based on the back projections. The back-projection may comprise lines in 3D in the volume such as in linear-projections, but may comprise more general curved lines, surfaces or volume elements, in particular (but not only) if non-linear projection operations are used. The location(s) of the footprints may be a point coordinate, a group of coordinates, a bounding box, a segmentation, etc.

In embodiments, the processing may include adjusting the computed location for consistency with the projection footprints. In particular, one such consistency may require the back-projections to intersect in a single point. If it is found they do not, the projection geometry may be varied and the model computes updated locations in one or more iterations, until sufficient consistency is achieved. It may not be necessary for all back-projections of interest to intersect. At least intersection of two back-projected sets (such as two lines) may be considered sufficient.

In embodiments, the method includes providing the output data for additional processing, the said additional processing including one of: i) registering the 3D volume, or at least a part thereof, on an atlas based on the output data, ii) displaying the output data on a display device, iii) storing the output data in a memory, iv) processing the output data in a radiation therapy system, v) controlling a medical device based on the output data.

In embodiments, the method includes selecting at least one of the at least one plural projection based on one of: i) earlier one or more projections processed by the machine learning model and ii) the projection geometry for at least one of the received projections based on the structure of interest.

The projection geometry may be adjusted in one or more iterations until the projection footprints fulfil a pre-defined objective such as sufficient separation from surrounding structures. Edge gradient thresholding may be used to define the separation goodness.

In embodiments, the different projection geometries include different projection directions, but may include instead other changes such as projection mode, orthogonal, parallel, central etc or varying distance between viewpoint and projection surface. In general, changing the projection geometry may include changing the manner in which voxels in the volume contributed to data points in projection, and/or (re-)defining which such voxels are to contribute (if at all).

In embodiments, the structure of interest relates to at least a part of a mammal spine such as a vertebra, but may relate instead to any other anatomical feature, such as any other bone portion, a part of a vasculature, etc.

In embodiments, the medical imaging apparatus is of the tomographic type.

In embodiments, the imaging apparatus is any one of i) an X-ray based computed tomography, CT, scanner and ii) a magnetic resonance imaging apparatus.

In another aspect there is provide a method of training, based on training data, a machine learning model for facilitating computing, based on input data, a location in an at least 3D volume of a structure of interest, the input data comprising at least one projection at across or into an at least 3D image volume. The training method may include adjusting parameters of the model based on the training data. The training data may include training input (projections) and associated target (location in 3D of target structure). For example, the model parameters may be adjusted based on how outputs of the model, received in response to the model processing the input training data, differ from the associated targets. Gradient based methods may be used to adjust the current parameter(s) based on the deviation. The training method may be iterative, may be a one-off or may be repeated based on new training data.

The training data may include annotated projections, annotated with an indication of the respective location in 3D of the structure of interest. The training data may be based on historical volumes as may be found in medical databases, or may be at least partly generated (synthesized).

Thus, in another aspect there is provided a method of generating at least a part of the training data. The method may include using a given volume from one or more patients and known location of the structure of interest. The method may include computing training projections of the volume at varying projection geometries. The volume may be obtained by a medical modality that is different from the modality (target modality) for which the model is to be trained. For example, the volume may be an MRI volume whilst the model is trained for CT for example. The projection operation may use a transfer function to modify the obtained projections to a achieve an image value distribution or pattern in the projections that corresponds to the target modality.

In another aspect there is provided:
a) a program which, when running on at least one computing system or when loaded onto at least one computing system, causes the at least one computing system to perform the method according to any one of the preceding claims;
b) and/or at least one program storage medium on which the program is stored;
c) and/or at least one computing system comprising at least one processor and at least one memory and/or the at least one program storage medium, wherein the program is running on the at least one computing system or loaded into the at least one memory of the at least one computing system;
d) and/or a signal wave or a digital signal wave, carrying information which represents the program;
e) and/or a data stream which is representative of the program.

The above signal wave may be (physical, for example electrical, for example technically generated) signal wave, for example a digital signal wave, carrying information which represents the program, for example the aforementioned program, which for example comprises code means which are adapted to perform any or all of the steps of the method according to the first aspect. The computer program stored on a disc may be a data file, and when the file is read out and transmitted it becomes a data stream for example in the form of a (physical, for example electrical, for example technically generated) signal. The signal can be implemented as the signal wave which is described herein. For example, the signal, for example the signal wave is constituted to be transmitted via a computer network, for example LAN. WLAN, WAN, for example the internet. The invention according to the second aspect therefore may alternatively or additionally relate to a data stream representative of the aforementioned program.

In a further aspect, the invention is directed to a non-transitory computer-readable program storage medium on which the program according to the fourth aspect is stored.

In another aspect there is provided a medical image processing system, configured to:
a) receive input data comprising at least one projection of an at least 3D image volume generated by a medical imaging apparatus;
b) process the input data by using at least a trained machine learning model (M) to at least facilitate computing a location in the 3D volume of a structure of interest; and
c) output output data indicative of the said location.

In another aspect there is provided a medical arrangement, comprising:
a) the system as mentioned above; and
b) any one of i) a medical imaging apparatus for generating the at least 3D volume, ii) a medical device (MD) controllable by the output data.

In another aspect there is provided a computer-implemented training system configured to train, based on training data, a machine learning model for facilitating computing, based on input data, a location in an at least 3D volume of a structure of interest, the input data comprising at least one projection at across or into an at least 3D image volume.

In another aspect there is provided a computer-implemented system for generating training data for training system.

Whilst main reference is made herein to x-ray tomographic imaging and linear projections, this is not at the exclusion of other imaging modalities of the tomographic type that allow generating 3D or higher dimensional volume image data and use of non-linear projection operators to achieve dimensional reduction to facilitate ML processing.

### Definitions

In this section, definitions for certain terminology used herein is included as part of the present disclosure.

### Computer Implemented Method

Steps or merely some of the steps (i.e. less than the total number of steps) of the methods can be executed by a single one or more than one computer. An embodiment of the computer implemented methods is a use of the computer for performing the medical imaging processing or training method. An embodiment of the computer implemented methods are a methods concerning the operation of the computer such that the computer is operated to perform one, more or all steps of the method.

The computer for example comprises at least one processor and for example at least one memory in order to (technically) process the data, for example electronically and/or optically. The processor being for example made of a substance or composition which is a semiconductor, for example at least partly n- and/or p-doped semiconductor, for example at least one of II-, III-, IV-, V-. VI-semiconductor material, for example (doped) silicon and/or gallium arsenide. The calculating or determining steps described are for example performed by a computer. Determining steps or calculating steps are for example steps of determining data within the framework of the technical method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right. The term “computer” includes a cloud computer, for example a cloud server. The term “cloud computer” includes a cloud computer system which for example comprises a system of at least one cloud computer and for example a plurality of operatively interconnected cloud computers such as a server farm. Such a cloud computer is preferably connected to a wide area network such as the world wide web (WWW) and located in a so-called cloud of computers which are all connected to the world wide web. Such an infrastructure is used for “cloud computing”, which describes computation, software, data access and storage services which do not require the end user to know the physical location and/or configuration of the computer delivering a specific service. For example, the term “cloud” is used in this respect as a metaphor for the Internet (world wide web). For example, the cloud provides computing infrastructure as a service (IaaS). The cloud computer can function as a virtual host for an operating system and/or data processing application which is used to execute the method of the invention. The cloud computer is for example an elastic compute cloud (EC2) as provided by Amazon Web Services™. A computer for example comprises interfaces in order to receive or output data and/or perform an analogue-to-digital conversion. The data are for example data which represent physical properties and/or which are generated from technical signals. The technical signals are for example generated by means of (technical) detection devices (such as for example devices for detecting marker devices) and/or (technical) analytical devices (such as for example devices for performing (medical) imaging methods), wherein the technical signals are for example electrical or optical signals. The technical signals for example represent the data received or outputted by the computer, such as the localization result of the structure of interest. The computer is preferably operatively coupled to a display device which allows information outputted by the computer to be displayed, for example to a user. One example of a display device is a virtual reality device or an augmented reality device (also referred to as virtual reality glasses or augmented reality glasses) which can be used as “goggles” for navigating. A specific example of such augmented reality glasses is Google Glass (a trademark of Google, Inc.). An augmented reality device or a virtual reality device can be used both to input information into the computer by user interaction and to display information outputted by the computer. Another example of a display device would be a standard computer monitor comprising for example a liquid crystal display operatively coupled to the computer for receiving display control data from the computer for generating signals used to display image information content on the display device. A specific embodiment of such a computer monitor is a digital lightbox. An example of such a digital lightbox is Buzz®, a product of Brainlab AG. The monitor may also be the monitor of a portable, for example handheld, device such as a smart phone or personal digital assistant or digital media player.

The invention also relates to a program which, when running on a computer, causes the computer to perform one or more or all of the method steps described herein and/or to a program storage medium on which the program is stored (in particular in a non-transitory form) and/or to a computer comprising said program storage medium and/or to a (physical, for example electrical, for example technically generated) signal wave, for example a digital signal wave, carrying information which represents the program, for example the aforementioned program, which for example comprises code means which are adapted to perform any or all of the method steps described herein.

Within the framework of the invention, computer program elements can be embodied by hardware and/or software (this includes firmware, resident software, micro-code, etc.). Within the framework of the invention, computer program elements can take the form of a computer program product which can be embodied by a computer-usable, for example computer-readable data storage medium comprising computer-usable, for example computer-readable program instructions, “code” or a “computer program” embodied in said data storage medium for use on or in connection with the instruction-executing system. Such a system can be a computer; a computer can be a data processing device comprising means for executing the computer program elements and/or the program in accordance with the invention, for example a data processing device comprising a digital processor (central processing unit or CPU) which executes the computer program elements, and optionally a volatile memory (for example a random access memory or RAM) for storing data used for and/or produced by executing the computer program elements. Within the framework of the present invention, a computer-usable, for example computer-readable data storage medium can be any data storage medium which can include, store, communicate, propagate or transport the program for use on or in connection with the instruction-executing system, apparatus or device. The computer-usable, for example computer-readable data storage medium can for example be, but is not limited to, an electronic, magnetic, optical, electromagnetic, infrared or semiconductor system, apparatus or device or a medium of propagation such as for example the Internet. The computer-usable or computer-readable data storage medium could even for example be paper or another suitable medium onto which the program is printed, since the program could be electronically captured, for example by optically scanning the paper or other suitable medium, and then compiled, interpreted or otherwise processed in a suitable manner. The data storage medium is preferably a non-volatile data storage medium. The computer program product and any software and/or hardware described here form the various means for performing the functions of the invention in the example embodiments. The computer and/or data processing device can for example include a guidance information device which includes means for outputting guidance information. The guidance information can be outputted, for example to a user, visually by a visual indicating means (for example, a monitor and/or a lamp) and/or acoustically by an acoustic indicating means (for example, a loudspeaker and/or a digital speech output device) and/or tactilely by a tactile indicating means (for example, a vibrating element or a vibration element incorporated into an instrument). For the purpose of this document, a computer is a technical computer which for example comprises technical, for example tangible components, for example mechanical and/or electronic components. Any device mentioned as such in this document is a technical and for example tangible device.

### Display Device

is any output device capable of displaying information. It includes for example stationary or mobile monitors, either standalone or as part of another device such as a laptop desktop, tablet smart phone etc. Display device includes a screen portion capable of being modulated to represent data, information etc. in particular a visualization of the location of the structure of interest as provided by the system o method. Display device may further include herein augmented reality devices including head mounted displays or other wearables capable of projecting or otherwise displaying data or a stream of such data, by projection technology or in any other manner.

### Location

relates to a single point coordinate or a group of such points or their coordinates within a 3D or higher dimensional image volume. The location may pertain to an image structure such as distribution of image values in the volume, a region, a geometrical shape, etc or other in-image volume feature. The location may include a segmentation or any other form or localization such as by bounding box or other geometrical shapes and/or features thereof such as their center, edge, or corner points, etc. The location may pertain to a landmark. A landmark may relate to an anatomical feature which is always or in most cases identical, or least recurs with a in general high degree of similarity in the same anatomical body part of multiple patients. Typical landmarks are for example the epicondyles of a femoral bone or the tips of the transverse processes and/or dorsal process of a vertebra. The location when express in terms of said points may represent such landmarks. A landmark which lies on (for example on the surface of) a characteristic anatomical structure of a body part can also represent said structure. The landmark can represent the anatomical structure as a whole or only a point or part of it. A landmark can also for example lie on the anatomical structure, which is for example a prominent structure. An example of such an anatomical structure is the posterior aspect of the iliac crest. Another example of a landmark is one defined by the rim of the acetabulum, for instance by the center of said rim. In another example, a landmark represents the bottom or deepest point of an acetabulum, which is derived from a multitude of detection points. Thus, one landmark can for example represent a multitude of points. As mentioned above, a landmark can represent an anatomical characteristic which is defined on the basis of a characteristic structure of the body part. Additionally, a landmark can also represent an anatomical characteristic defined by a relative movement of two body parts, such as the rotational center of the femur when moved relative to the acetabulum. Landmarks may further relate to vertebrae, a group of vertebrae or other features of a mammal spine.

### Imaging

In the field of medicine, “imaging”. (also called imaging modalities and/or medical imaging modalities) is used to generate image data (for example, two-dimensional or three-dimensional image data or higher dimensional) of anatomical structures (such as soft tissues, bones, organs, etc.) withing the human body. Transmission and emission imaging modalities are envisage herein. The term “medical imaging” is understood to mean (advantageously apparatus-based) imaging methods such as for instance computed tomography (CT), cone beam computed tomography (CBCT, such as volumetric CBCT), other than cone-beam CT, x-ray tomography, magnetic resonance tomography (MRT or MRI), sonography and/or ultrasound examinations, and positron emission tomography. Examples for medical imaging modalities applied by medical imaging methods are: X-ray radiography, magnetic resonance imaging, medical ultrasonography or ultrasound, endoscopy, elastography, tactile imaging, thermography, medical photography and nuclear medicine functional imaging techniques such as positron emission tomography (PET) and Single-photon emission computed tomography (SPECT).

Imaging Geometry in general relates to the mutual spatial constellation of an imaged object (such as an anatomy of interest), an imaging/interrogating signal source (such as an X-ray source, MRI coil, etc) capable of generating such a signal to interact with the object, and/or a detector system capable of detecting the said signal after such interaction. For example, in transmission imaging, such as CT, the said signal may be generated by an X-ray source in form of a radiation beam propagating through the object and having a certain shape, such as wedge, cone, fan or parallel. Imaging geometry may include a position/orientation/pose of said source and/or shape of said radiation beam, direction of said beam relative to the object. In modalities other than transmission imaging, imaging geometry may be realized in other terms than beams, such as in MRI, nuclear or other.

Imaging geometry may include a distance and or mutual orientation between source and detector system. The imaging geometry may include a distance and or mutual orientation between source or detector system relative to the object.

### Projection Operation

is to be construed broadly and does not only include forward projection by summation along respective projection lines but further includes all manner of weighted or otherwise modulated projection operations. For example, a projection line may not extend all across the volume but may terminate inside the volume to define sectional imagery in the volume rather than projection images outside the volume. Weighted projection operations may be used based on a weight function for example to so define an arbitrary intersection imagery through the image volume. The projection lines envisaged herein can have any direction in space so long as they intersect the image volume.

Projection operation may be defined by a projection geometry. The projection geometry is preferably independent and different from the imaging geometry. For example, in relation to transmission imaging, such as CT, the directions of projection lines are in general different from the direction of projection lines used for acquiring projection raw data from which the volume was reconstructed. Thus, all or at least some of the projections obtained by the projection operation, is different (synthesized) from the projection raw data.

The projection operation is preferably based on voxels inside the volume (representative of points within the patient), at the exclusion of surface voxels of the volume (representative of points on the patient surface), or in addition to such surface voxels of the volume. Preferably, each projection direction is based on at least one voxel inside the volume, some or each projection. Generally, the projection operation allows extracting information and projecting same on to a lower dimensional representation (referred to as projection or projection image). Some or each such projection includes contribution from one or more voxel inside the volume. This lower dimensional representation is more efficient is terms memory and CPU requirements for implementing the machine learning model in training and deployment.

Projection lines may be understood as a special case of projection geometry. The projection geometry may be orthogonal and may thus be defined by a single direction, or may be central, and may thus be defined by a set of lines emanating in divergent manner from a single viewpoint in whatever beam shape. In general, projection geometry defines which part of the volume V contributes to each data point in a projection and how the data point is computed such as via summation (such as in forward projection operations), by transfer function, weights, or in any other algebraic operation, or a combination of some of all of the foregoing. The volume may be three-dimensional (3D, N=3) or may be higher with dimension N>3. The dimensions may be spatial, but may also include in addition a temporal dimension, such as a time series of volumes Vt.

More general still, projection operations as understood herein are furthermore not confined to linear-projections, so are in particular not necessarily along projection lines as mentioned above and thus include herein non-linear projection operations that do not have directionality. Thus, the projection geometry is not necessarily defined in terms of lines and their directions. That is, general projection mappings are envisaged herein such as defined below at (4) that defined more general projection geometry. The general projection mapping defines one or more sets of voxels in the volume V, and how they contribute (if any) to any given data point in a given projection. Those sets in the volume are not necessarily linear, even in a 3D volume, but may instead or in addition be defined by a curve line(s) or surface(s). Voxels are used herein in a general sense to indicate a respective image value at a respective location in an at least N-dimensional image volume, N≥3. The general projection is a mapping from the last three-dimensional image volume to a space of dimension lower than N to allow more memory efficient and faster processing as compared to processing volume V. In general, the general projection mappings envisaged herein are implemented as model equations that model some dimensionality reducing operation or strategy.

### Machine Learning

includes a computerized arrangement to implement a machine learning (“ML”) algorithm. ML algorithms may operate to adjust a machine learning model so that the model is capable performing (“learn”) a task, such as localizing a structure in an image volume based on projections in relation to said volume. Adjusting or updating the model is called “training”. Performance of ML model in relation to the task may improve measurably, with training experience. Training experience may include suitable training data and exposure of the model to such data. Task performance may improve the better the data represents the task to be learned. Training experience helps improve performance if the training data well represents a distribution of examples over which the final system performance is measured. Performance may be measured by objective tests based on output produced by the model in response to feeding the model with test data. Performance may be defined in terms of a certain error rate to be achieved for the given test data. See for example, T. M. Mitchell, “Machine Learning”, page 2, section 1.1, page 6 section 1.2.1. McGraw-Hill, 1997.

### BRIEF DESCRIPTION OF THE DRAWINGS

In the following, the invention is described with reference to the appended figures which are not to scale. The scope of the invention is however not limited to the specific features disclosed in the context of the figures, wherein:—

FIG. 1 Shows a schematic block diagram of a medical imaging arrangement;

FIG. 2A Shows a schematic block diagram of a localizer system for localising a location in an image volume according to one embodiment;

FIG. 2B Shows such a localizer system according to a second embodiment;

FIG. 3 Illustrates a projection operation;

FIG. 4 Illustrates a back-projection operation;

FIG. 5 Shows a schematic block diagram of a machine learning model architecture;

FIG. 6 Shows a block diagram of a training system with optional generation of training data for training a machine learning model;

FIG. 7 Shows a flow chart of a computer-implemented method for localizing a structure of interest in a 3D volume; and

FIG. 8 Shows a flow chart of a computer implemented method of training a machine learning model and optionally generating training data for such training.

### DESCRIPTION OF EMBODIMENTS

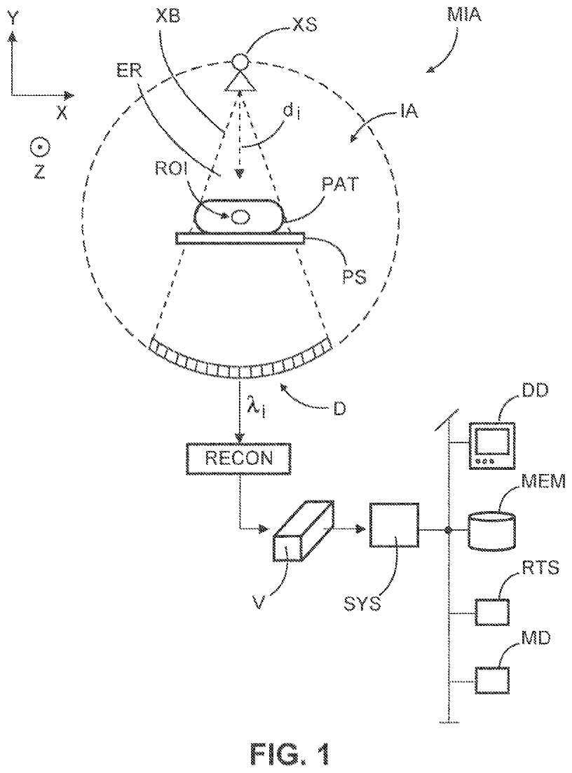

With reference to FIG. 1 there is shown a schematic block diagram of a medical imaging arrangement MIA.

The arrangement MIA includes a medical imaging apparatus IA configured to generate image data. The image data may be processed by a data processing system SYS.

Broadly, the data processing system SYS may be computer-implemented on one or more computing systems PU to facilitate, based on the image data, medical applications, protocols and procedures. In particular, the system SYS is operable as a localizer system that allows localizing in the image data a structure of interest. The system SYS may henceforth be referred to as the localizer or localizer system. The structure of interest a may be representative of a region of interest, such as an anatomy, part of anatomy, an organ, a group of organs or tissue types of a patient PAT. The patient may be a human or animal patient.

The imaging arrangement MIA may be used for therapeutic or diagnostic purposes. The imaging apparatus IA is preferably configured for generating high dimensional imagery such as three-dimension (3D) image data, or higher still, such as, in particular, four-dimensional data (4D), such as a time series of 3D image data. Such at least 3D image data may be aptly referred to herein as an image volume V. The location P of the structure of interest a within the volume V as computed by the localizer system SYS may be made available for display on a display device DD. A visualizer component VIZ may render a grey value or color-coded rendition of the structure and its location For example, the visualizer VIZ may generate based on the computed location P a graphic display for display on the display device DD. The visualizer, such as renderer module, may interface with graphics circuitry to drive the display device DD thus causing visualization of the graphics display on a screen of the display device DD. The graphics display so generated may include a graphical indicator representing the computed location P. The graphics display may include the graphical indicator superimposed on a view on the image volume. The computed location P(σ) of structure of interest a may not necessarily be provided in graphical form, but may be provided in textual/numerical form as control data for example, or the location may be displayed as coordinate numbers in a text box, etc.

The computed location P may be stored in a memory MEM or may be otherwise processed. The computed location P may include one or more spatial coordinates in 3D space, indicative of the structure o's location within the volume V. The location may be a point-location or a region. The computed location, which may written herein as P(σ), may be provided as a bounding box. Bounding box (“bbox”) should be construed herein in the general sense as any geometrical shape, not necessarily rectangular, that at least partly if not fully encloses, or otherwise spatially defines, the location of structure σ. Thus, the bounding box may be any polytope, sphere, ellipsoid, or, when rendered in 2D, polyhedron, circle, ellipse, etc. For example, the bounding box may be a quackilateral. The bounding box may be defined by [(p1,p2,p3), w, d, h], with (p1,p2,p3) the spatial coordinates in 3D of a corner, edge or center or other feature of the bbox, and w,d,h the width, height and depth of bbox. The location P(σ) may thus be defined by the 6-tuple of [(p1,p2,p3), w, d, h] as provided by localizer SYS relative to a coordinate system in spatial image domain (on which more below), the portion of space in which the image volume V is conceptually located. More generally, the bbox may be taken herein as the smallest polytope of a given type to include all of the structure of interest a or the relevant part thereof. bbox may have its edges aligned parallel to the underlying spatial coordinate system of the image volume, but such alignment is not a necessity herein. In case there is no such alignment, more than six coordinates (as in the example above) may be required.

Other than, or in addition to, displaying, the processing of the computed location P may include controlling of one or more medical devices MD based on the location P. Such medical devices may include for example an interventional robot, navigational planning system in a trauma setting or other interventions, such as heart procedures, or other medical procedures. Controlling of diagnostic devices based in location P is also envisaged.

In embodiments, the location P of structure a may be made available to a radiation treatment planning system RTS for example. Such a planning systems RTS may be configured to draw up a treatment plan including control parameters for a radiation delivery apparatus, such as a linear accelerator. In radiation therapy, the control parameters are applied to control the radiation delivery apparatus. The so controlled radiation delivery apparatus delivers a high energy radiation beam to a lesioned site in a target volume according to the plan, to neutralize cancer cells. Radiation planning systems RTS may be configured to solve a complex constraint optimization problem to deliver radiation dose subject to certain dose constraints. The dose constraints may prescribe that a certain minimum dose is delivered to the target volume that includes cancerous tissue, but equally, that dose to certain organs at risks (such as around the target volume) is not to exceed as certain maximum dose threshold. Thus, healthy tissue is spared whilst dose delivery is focused on the cancerous tissue where it is needed. A sufficiently accurate knowledge of the location of the organs at risk and of the target volume may be beneficial. Thus, the localization capabilities of the proposed system SYS may be used with benefit in radiation treatment planning context as envisaged herein in embodiments for example to provide locations P of organs at risks and/or of target volume in the image volume, as planning systems RTS often use such image volumes as a basis for planning. Solving the constrained optimization may consume much CPU time and imprecise location information may render such efforts futile, or, even worse, may result in unsuccessful treatment, with healthy tissue compromised, and/or cancerous tissue continuing to proliferate. The localizer system SYS may provide precise location information P with low turnaround thus facilitating timely and successful radiation therapy, as one example of the host of applications envisaged herein for the proposed image-based structure localizer system SYS.

Another processing option based on the location P is registering this with an anatomical atlas. Registering the location allows mapping the location to an anatomical label or feature, such as a natural language description of the structure, such as “n-th vertebra”, etc. Procedures commonly involved in the registration of 3D volumes (between themselves or to an anatomical atlas) are typically optimization-based iterative approaches. Their efficiency can highly benefit from a good initialization (e.g. derived from the lower-dimensional machine learning model prediction of the 3D localization of certain anatomical locations) and faster processing times required for the auxiliary guidance provided by e.g. machine learning anatomy localization models.

In order to facilitate explanation of operation of the localizer system SYS in more detail, reference is first made to the imaging apparatus IA. The imaging apparatus IA is configured for generating the at least three-dimensional image volume V. The imaging apparatus IA includes an image signal source XS and a detection system D. The imaging signal source generates an interrogation signal which interrogates patient tissue for the quantity of interest to be imaged. The interrogating signal, after interaction with the patient tissue, is detected by the detection system D as measurements. A digital acquisition unit (not shown) converts the detected measurement signal into a set of digital values. The set digital values may be processed by imaging arrangement MIA into the at least three-dimensional image volume V.

Specifically, imaging modalities envisaged herein in particular are of the tomographic type. Such tomographic imaging modalities include, for example, magnetic resonance imaging (MRI) or emission type imaging such as nuclear imaging including PET, or SPECT. OCT (Optical coherence tomography) and 3D US (ultrasound) may also be envisaged herein in some embodiments.

For example, in MRI, source XS and detector D includes coils arranged in different spatial directions that emit and receive radiofrequencies signals in relation to the region of interest in a magnetic field. The received resonance signals may then be used to compute the least 3D MRI image volume. In emission imaging, the source is a prior administered radioactive tracer substance within the patient. The detector system D may include a gamma-ray sensitive detector ring arranged around the region of interest, configured to pick up decay events caused by the substance to build up the image volume V.

Another type of tomographic modalities mainly envisaged herein include transmission imaging, in particular x-ray based tomographic imaging. This may be realized by a tomographic CT scanner IA as illustrated in FIG. 1. The CT scanner IA may be of the stationary type as shown, but mobile systems are not excluded. C-arm or U-arm scanners for interventional imaging are also envisaged herein.

The tomographic x-ray type imaging apparatus IA may include, as the imaging signal source, an x-ray source XS, such as X-ray tube. The X-ray tube, upon application of a tube voltage and tube amperage, causes an x-ray beam XB to issue forth from its focal spot. In data acquisition (also referred to as imaging), the x-ray source passes through an examination region ER, interacts with patient tissue and is then detected as X-ray sensitive detector D.

During imaging, the patient PAT, or at least the region of interest ROI, resides in the examination region ER. The examination region ER is a portion of 3D space between the x-ray source XS and the x-ray sensitive detector D. The patient may sit, squat or otherwise assume a certain pose in the examination region ER during imaging. For example, the patient may be lying on a patient support PS during imaging as shown.

The CT scanner IA, or the imager IA in any other modality, is configured so that its imaging geometry during imaging can be adjusted. Imaging geometry may refer in embodiments to the mutual spatial relationship or constellation between the imaged region of interest, the signal source XS and/or the detector D. In the embodiment illustrated in FIG. 1, the adjusting of the imaging geometry allows acquisition of projection imagery λᵢ along different acquisition projection directions d, relative to the ROI in the examination region ER. This can be achieved in embodiments by rotation of a gantry (not shown) around the region of interest. The gantry may include the detector and the x-ray source and thus the rotation of the gantry causes rotation of an optical axis of the imager IA. The optical axis is an imaginary line that may be run between the focal spot and a point on the detector, such as a mid-point on the detector's radiation sensitive layer or surface. In particular, at least the source XS may rotate with the gantry round the region of interest ROI, thus allowing acquisition of projection imagery λᵢ along multiple spatial directions. A full revolution around the region of interest is not necessarily required herein. In the generation of scanner shown in FIG. 1, the detector is likewise rigidly mounted on the gantry opposite the source XS and across the examination region, thus source and detector rotate together in opposed spatial relationship around the region of interest. However, this setup is not necessarily required. For example, the detector may be arranged as a stationary detector ring circumscribing the region of interest so that it is only the source XS that mechanically rotates with the gantry around the region of interest. In 4^{th} generation scanners, no mechanical rotation is required at all as there are, in addition to the detector ring, multiple sources arranged in a source ring around the region of interest. Any of the above-described CT designs are envisaged herein, FIG. 1 merely illustrating one example of such a design.

The X-ray sensitive detector D has preferably a 2D layout where the X-ray sensitive layer is made up of a matrix of radiation sensitive pixel. Thus, each acquired projection image is 2D (two-dimensional). The detector layer may be in a plane or curved as shown in FIG. 1. A range of beam geometries such as cone beam, fan beam, and wedge beam, etc. are envisaged herein. Preferably however cone beam or others are used that allow fully 3D acquisition. However, this does not exclude section-wise acquisition in different sectional planes as can be done with detector designs that include merely a one-dimensional arrangement of detector pixels. The image axis Z extends perpendicularly into the drawing plane of FIG. 1 and essentially coincides with the patient's longitudinal axis. Standard section image planes are perpendicular thereto, with (X,Y) co-ordinates.

Scan paths describe the mechanical (or, in 4^{th} generation scanners, “virtual”) motion of the source XS during acquisition. The scan path may be helical to reduce acquisition time. Specifically, whilst the projection imagery is acquired (for example during rotation of source XS around the region of interest), there is relative translational motion, along the imaging axis Z, between source XS and region of interest, for example by advancing the gantry or the patient support PS. However, scan paths that are confined in a respective plane for a given acquisition cycle, with translation in between acquisition cycles such as in the said section-wise acquisition protocols, are not excluded herein.

The projection imagery λ=λᵢ is acquired in projection domain. Projection domain is the 2D space which is defined by the X-ray radiation sensitive layer (the set of detector pixels) of the detector D. According to the Beer-Lambert modelling assumption, the detected intensities represent attention modulated line integrals through patient tissue irradiated by the incoming radiation beam XB. To obtain sectional imagery, of which the image volume V is made up, a reconstructor RECON is used. Reconstructor RECON implements a tomographic reconstruction algorithm that transforms the projection imagery into the image volume V situated in imaging domain. Tomographic reconstruction algorithms envisaged include filtered back-projection (FBP), Fourier based methods, algebraic, or iterative reconstruction algorithms. Imaging domain is a conceptual 3D space that represents the examination region, the portion of space that is formed between the x-ray source and the detector and in which the region of interest ROI resides during imaging. Specifically, imaging domain is conceptually made up of a 3D grid of image elements or 3D voxels. The reconstructor RECON computes the image volume V in image domain. Computing the image volume V(A) results in populating the voxels with image values.

Navigation, and thus localization, in such high dimensional image volume V may be challenging if unaided, in particular in stressful situations such a trauma settings, or with less experienced staff etc. The proposed localizer system SYS allows rapid and accurate localizing of the structure of interest σ in the reconstructed volume V. For example, the structure a of interest may relate to the spine, in parts or as whole, for the definition of an organ at risk in radiation therapy planning. Other structures of interest may a may include in parts or whole a vessel tree. Vessel tree structures represent a part of the vasculature, such as cardio-vasculature. Such image volumes V may support cardio-interventions for example. Generating such volumes to image for vessels or other soft tissue may require prior administration of a contrast agent to enhance contrast, envisaged herein in embodiments.

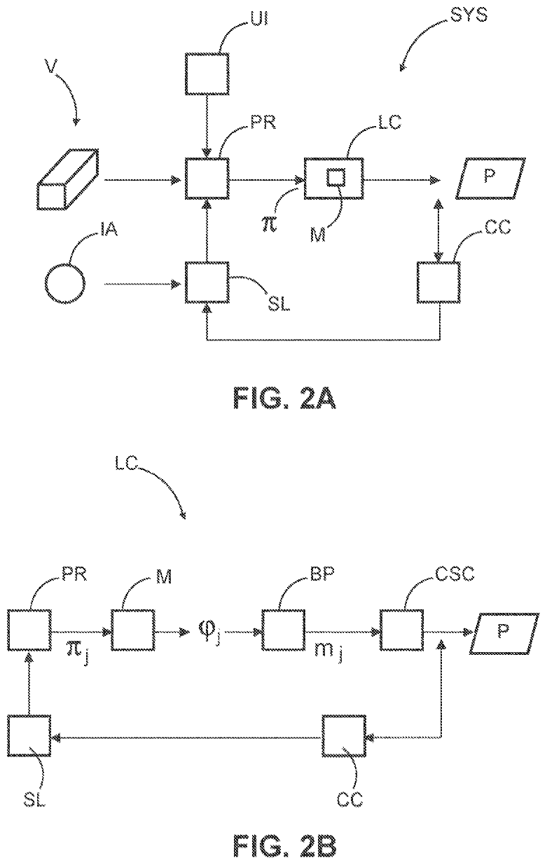

FIG. 2 shows a schematic block diagram of the localizer system SYS. The system may include a localizer component or module LC. The localizer module LC may be implemented or includes a trained machine learning (“ML”) model M. Based on the volume V, the machine learning model M computes structure σ's location P(σ). However, rather than having the machine learning model M process the image volume V as a whole (or at least across all its dimensions), a lower dimensional presentation of at least parts of the volume is obtained first by a projection operator PR. The projection operator PR provides one or more lower dimensional projection representation(s) (referred to herein as the “projection(s)”), and it is this projection(s) π=π(V) that is processed by the machine learning model instead of the volume V. The ML-processing of such one or more projection π instead of the volume (or high dimensional parts thereof) allows for quick, memory- and CPU-efficient localization of the structure of interest, in even high dimensional image volumes. Whilst reference is made herein to the structure of interest a, it will be understood herein that the localizer component may operate on multiple such structures in sequence or concurrently.

The projection operator PR may be implemented as a projection mapping, such as forward projection across the volume to obtain digitally reconstructed radiographs (“DRR”) for example. A single one π, or plural such projections πj, are obtained and it is these o the single projection that are/is fed into the machine learning model M for processing into the in-volume location P. If there are plural such projections πj, these may be processed sequentially or jointly at once by the ML model M. In one embodiment, the machine learning model regresses the one or more projections T into the structure of interest σ's location P(σ) within the volume V. Processing such projections instead of the volume itself allows more efficient memory allocation strategies, with faster overall processing.

The structure of interest σ may include the whole or a part of the human spine for example such a vertebra or part thereof. However, localizing other structures of interest representative of other organs is not excluded herein and is indeed specifically envisaged, such as part of a (contrasted) vasculature of the heart, arm, leg etc, or a portion of the lung for example, or any other organ or anatomy or their landmark(s), etc. Bone-based landmarks or structures may be preferred herein, at least for X-ray, CT or other transmission-based imaging modalities for clear edge gradients of such structures. Such clear, well-defined edge gradients may also be observed for other landmarks such as the lobe fissures in lung projection imagery. Other landmarks may include tip of nose in conjunction with top part of the ears, specifically of the helix. This landmark combination may be used as an indicator for head position. Another example may include one or more landmarks in the aortic arch, such as the lowest part of the arch, between ascending and descending aorta for example, or other parts. This may facilitate automatic localization, such as segmentation, of the aorta, which may be use in some medical applications, such as mage-derived input function for so-called dynamic/gated PET acquisitions for example. Thus, as will become apparent from the above, landmarks as used herein may comprise disjoint image structures σ=Uᵢσᵢ at that together defined the structure of interest. A number of landmarks may be used together, such as arm pose and/or inclination of knee(s), etc for an indication of a human pose.

Whilst in principle some of the original, measured, projection data λ may be used by the localizer component LC, it is mainly such artificially generated projections π along different projection directions l that are processed by the localizer component LC into the sought location P(σ). Thus, a greater and more varied pool of projection views can be obtained which allows more efficient and more precise computation of the location P. This is because it is thought that this greater pool of projections π is likely to encode more relevant geometrical information content or at greater discriminative power. An information measure, such as entropy based, may be used to inform the selection along which directions the projector operator OP is to project to obtain the projection input π for model M to process. For example, in fixed CT scanners where the examination region ER is formed by a bore surround by a donut-shaped gantry, the projection directions for projection raw data λ are usually confined to directions perpendicular to patent's longitudinal/imaging/rotation axis Z. Projection directions e for the synthesized projections π are not so confined and can assume any desired angle relative to longitudinal axis Z. Alternatively, projection direction selection may be randomized and/or based on some anatomy-adapted heuristic, e.g. are chosen orthogonal to a (portion of the) curve of the spine, etc. A more general projection mapping Π implemented by the projector PR is also envisaged and the projections are not necessarily associated with such projection lines but instead with more complex subsets (2D or 3D) that may be curved or otherwise defined within the volumes. The projections are functions of image information in those sets and may be implemented in other algorithmic form than forward projection along lines for achieving the dimensional reduction envisaged herein. However, for illustration we will continue to refer mainly to projections geometries along lines and/or forward projection, with the understanding that this is but one embodiment.

The location P may be indicated by a single co-ordinate or a group of co-ordinates or indeed as a bounding box for example as mentioned above, depending on the configuration of the machine learning model M. In some embodiments, a segmentation or any other form of localization may be computed by the localizer component LC. In case of segmentation, the output is a binary or probability mask. Thus, each entry represents whether or not the respective voxel is part of the sought structure σ, or at which probability, respectively.

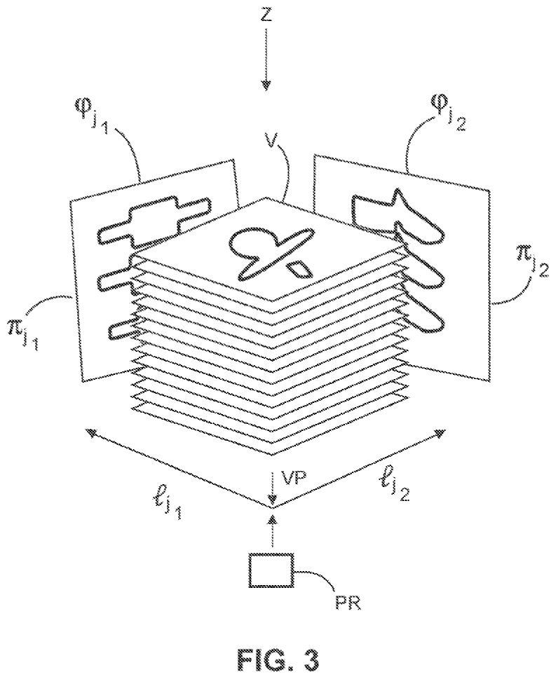

Operation of the projector PR in one embodiment for linear projection geometry is illustrated in FIG. 3. Projector PR may be operative to define, based on user input supplied through a user interface UI or randomly by a random generator (not shown), or automatically based on clinical knowledge, viewpoint(s) VP in 3D space in which the volume is located. Some or all viewpoints VP may be outside the volume V, or inside the volume V as required. From each viewpoint VP, a single one or more than one projection direction lⱼ is cast through the volume V and onto its associated projection surface. Thus, operation of projector PR may be defined in such projection-geometries by the triple of: i) set of one or more viewpoints, ii) one or more projection directions and, iii) one or more projection surfaces, each associated with the respective projection direction. Not all projection directions may be cast from the same viewpoint, as required. The projection surface may be a plane or a curved surface. If different directions are used, all projection surfaces may be plane, or all may be curved, or there is mix of plane(s) and surface(s), as required. User may be able to set projection operator parameters i)-iii) through user interface UI. Thus, operation of projection operator PR results in one or more projection images πⱼ, from or more viewpoint onto the same or different projection surfaces. The projection geometry may include orthogonal, parallel or central projections with divergent bundles of projection direction from a single viewpoint in arbitrary “virtual” beam shapes.

Two such projection directions from the same viewpoint VP are shown FIG. 3. However, as said, the same or different projection direction rays lⱼ may be cast from different viewpoints instead or in addition. Each projection operation along a given projection direction lⱼ from a given viewpoint and projection plane results in a respective projection (view or image) πj. Corresponding to the two example projection directions l_{j,j=1,2}, two such synthesized projection images π_{j, j=1,2} are illustrated in FIG. 3. The projections are synthesized in that there are not measurements as the original projection raw data images λ are and the projection geometry differs from the imaging geometry. The structure of interest σ in the volume may be represented by respective projection footprints or projection views φⱼ of the structure σ in the respective projection images πⱼ. If the projection directions are chosen appropriately, the respective one or more projection footprints φⱼ will allow accurate localization in 3D space of the location P of the structure σ. Thus, selection of projection directions by a selector SL or by user input UI may be required. However, such an appropriate prior-knowledge based selection of projection direction(s) is optional, as it is expected that if the model M has been trained on a large enough and suitably varied stock of training data (on which more further below), even a random and single one (or more) such projection π may be sufficient for the model M to estimate the 3D location P(σ) with sufficient accuracy. This is because ML approaches differ in their functioning from classical approaches that attempt to construct analytical closed form (eg, a formula) based on underlying modelling assumptions. No such, or only very general, assumptions are needed in ML. One such basic ML assumption is that there is latent mapping or relationship between the spatio-geometrical information encoded in the projections TT and in particular in the respective structure footprint they include, and the in-volume-location in 3D of the structure. This relationship is likely to depend on many factors, such as noise, imaging geometry but also anatomical features of the imaged patent as captured in the given image volume V. The interplay of these factors may be difficult, if not impossible, to model classically in closed analytical form. ML does not require such analytical modelling, but aims to approximate instead this latent mapping from implicit patterns that may be encoded in training data set, preferably drawn from patients in different demographics. In some (but not all) embodiments, the training data set may thus include in particular a suitably large number of historical such image volumes for the anatomy/structure of interest for the same or, preferably, for different patients from prior exams as may be held in medical records or databases. If the model M is trained on such a large and varied training data set of say, historical spine image volumes, even a single random projection across the given volume V may be sufficient to estimate the in-volume 3D location P(σ) of the structure of interest σ. It is thought that this is because the ML model may take into account all information in the projection image in context. For example, the mutual distance of the structure σ's footprint φ(σ) in the given projection π from other surrounding structures may be enough to scale this information correctly to extrapolate the correct location into 3D space. Such estimation capabilities may be boosted by providing the model M not only with the input projection π, but in addition with contextual data c as enriched input (π, c). This may make it easier for the model M to build a pattern of correlations. The contextual data c may include for example patient characteristics (sex, BMI, age, ethnicity, etc) and, optionally, may further include medical history data of the patient. The training data may be made more varied by data augmentation approaches, such as scaling, rotation etc, or other. As will be explained in more detail, training data may not necessarily include historical data, or not only, but may be synthesized instead or in addition, as will be explained in more detail below.

Even if the model M is trained on a large training set, or if such a sufficiently large training set was not available at the time of training, it may still occur that the predicted location is inconsistent for some reason. Such reasons may include inherent image noise or because of relatively low information content due to poor choice of the projection directions and the model, at its current training stage, may not be able to sufficiently resolve such inconsistency. Such prediction inconsistencies may arise for example if plural projections are used. This may result in not a single, conclusive location prediction P (which is wanted), but in different estimated locations P′ᵢ computed. A consistency checker CC may process, in particular evaluate, the output plural predicted locations P′ⱼ. If, for example, the plural computed locations P′ⱼ are not within a pre-defined neighbourhood volume, a signal is sent to a selector SL. The selector is then to select different, new projection directions and the procedure is re-run to obtain updated or new predicted locations P′ⱼ. If these are evaluated to be in close enough proximity, a single location P may be computed as final output by a combiner or consolidator CSC (shown below at FIG. 2B, but may be used also in this embodiment FIG. 2A). For example, a barycentre or average or other combination of the plural predicted locations P′ may be formed by consistency checker CC to compute, based on plural tentative locations P′ⱼ, the final output B. However, such consistency checker is optional and may not be required even if the locator component LC does process plural projections π as mentioned above. For example, instead of the locator component LC predicting a location P′ⱼ for each projection π separately, the locator component may be configured to process the plural projections πⱼ jointly as combined input for better robustness. The combined input may include the patient context data c.

As shown in FIG. 2A, localizer component LC may have its machine learning model compute the 3D location P end-to-end. That is, the machine learning model M is configured to transform the one or more input projections π directly into a location in 3D space, in particular within the volume V, to localize the structure of interest.

However, such end-to-end ML prediction from 2D space (or other lower dimensional space) into 3D (or higher dimensional) space is not necessarily required herein in all embodiments. FIG. 2B shows another embodiment not reliant on such ML end-to-end implementation. Specifically, this embodiment shows localizer component LC according to a different embodiment. In this embodiment, the localizer LC comprises two sub-components in series: the trained machine learning model M, and downstream of model M, a back projector BP. In this hybrid embodiment, partly ML and partly classical, ML model M is trained to map preferably plural projections πⱼ into a respective location in 2D for each of the projection footprints φⱼ. It is then the so obtained ML-predicted 2D locations p of structure σ's projection footprints φj that are passed on to the back projector BP. The back projector BP back-projects the 2D locations of the structure's projection footprints into 3D domain where the volume is located to obtain the 3D location P of the structure. Specifically, in one embodiment of linear projection geometry, back-projector BP casts respective lines mⱼ from the locations of the structure footprints back in the respective 2D space projection πⱼ back into 3D domain to obtain the location. It will be understood that whilst the end-to-end ML embodiment of FIG. 2A may be able to predict 3D location from a single projection given sufficient training and optional processing of patient contextual data, the embodiment in FIG. 2B with the back-projector BP stage may require at least two such projections to resolve into a single, conclusive 3D location P.

Similar to the case in FIG. 2A, the predicted location p by model M of projection footprint of structure σ in the single or respective projections π may be a respective single coordinate of a point or a group of coordinates or a 2D bounding box or segmentation mask, for example. 2D bounding box may be defined by a corner point and width and height.

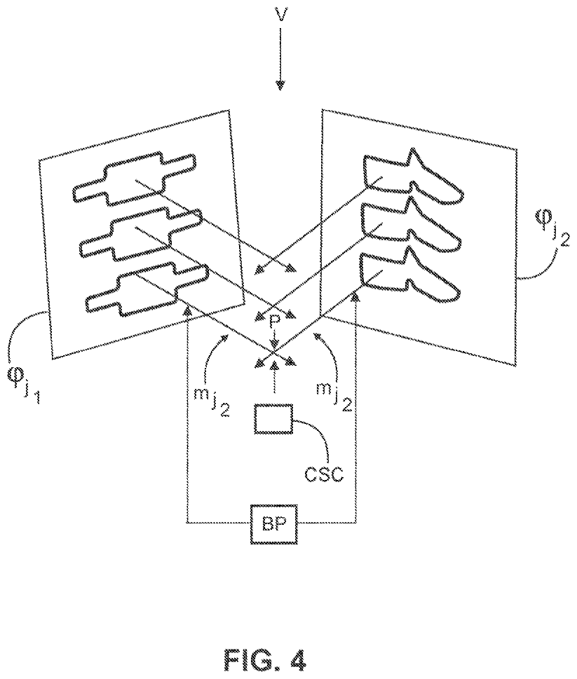

The back projection operation BP is illustrated in FIG. 4. Two or more such projection footprints φ_{j, j=1, 2} locations are back-projected into image domain along respective lines mⱼ_{₁} and mⱼ_{₂}. The combiner or consolidator component CSC may be configured to consolidate the back-projected lines into a single output for the location. For example, in embodiments combiner or consolidator component CSC may aim to find intersection of the back-projected lines mⱼ_{₁}, mⱼ_{₂} to so define sought 3D location P of the structure of interest. Again, because of image noise, rounding errors, slight prediction errors of model M or other adversarial factors, there may not necessarily be such a single intersection. Such a deficiency may be detected by a consistency checker CC for this embodiment. Consistency checker CC may determine remedial action to resolve the inconsistency. Checker CC may instruct selector component SL to re-run the computation using a different set of projection directions. All projection directions may be replaced, or only some (one or more) new ones are replaced, or more projection directions are used or the number is reduced. The prediction operation of localizer component LC is then re-run and the model predicts a new set of location for 2D projection footprints These are then back-projected, and checker CC rechecks for consistency, and so forth. A number of iterations may be run in this manner until a conclusive 3D location is found and can be combined into by combiner/consolidator CSC. In particular in the general case for non-linear projection geometries, the intersection of the back-projections may be 2D or 3D subsets. The location may then be computed by averaging or otherwise combining the information in those subsets in location P. For example, a location of a central point, barycenter or location of any other well-defined feature of the subset may be computed as the location P

Different consistency policies may be implemented by consistency checker CC. For example, once an intersection of at least two lines is found, or once two lines pass each other by less than a pre-defined error allowance, the consistency checker may be configured to be interpreted this as a resolution and this intersection point is then output as the estimated location P of the structure o. If there is a near miss within the allowance, a distance average of points on the two passing lines situated within the error allowance may be computed and output as the location P.

As mentioned, the selection of the initial projection directions used by projector PR may be done randomly or may be supplied as user input through user interface UI by user. For example, (clinical) user may supply through a graphical user interface proposed projection direction which may be revealing enough for the machine learning model to compute with sufficient accuracy the 3D location. There may be no need for the consistency checker CC to intervene.

In another embodiment, clinical knowledge on the geometrical properties such as symmetries, asymmetries etc of the anatomy of interest (and thus by extension, of the structure of interest σ) is used to select an appropriate set of projection directions from the start. Anatomical knowledge of the region of interest, such as of the spine for example, and the imaging geometry used for generating the initial volume V may be used to inform and compute a priori suitable projection direction to be used by the projector PR.

The bounding box, segmentation mask, heatmap, etc that defines the footprint φ location in 2D may be back-projected as a whole This may define surface(s) or sub-volume portions in volume V. Combiner CSC may compute intersection, barycenter or other well-defined point on the back-projected surfaces or sub-volumes to obtain location P.

Specifically for spine-related application the best, most revealing projection direction that yields the best spatial information, may vary from patient to patient, or even from one part of the spine to the other, due to the shape of the spine (e.g. scoliotic spines). Mutual constellations among the vertebrae may determine for example whether a neighbouring vertebrae shapes will overlap in the projection. A lateral spine-perpendicular view is typically a good option to find clear borders between vertebrae.

For any structures, not only relates to the spine, a suitable measure may be used to define the goodness of spatial information. In some cases, the best spatial information may be apparent on anatomical grounds and can be deterministically derived from the anatomical type of the structure of interest and the projection geometry used for obtaining the model. Thus, the projection directions to be employed by the projector PR should be chosen so that the structure of interest is sufficiently separatable from the surrounding image information.

In another embodiment, a sensitivity or perturbation analysis may be performed by the consistency checker CC to see how the computed result P or results P′ depend on choice of the projection directions lⱼ. By applying small perturbations to the initial projection directions, and by re-running the computation, inconsistencies may be resolved and a conclusive result in form of a single location P may be output. The anatomical knowledge/imaging geometry based selection of projection directions and the perturbation analysis may be used for any of the embodiments in FIGS. 2A,B.

Other optimization procedures are also envisaged as interplay between the consistency checker and the projection direction selector SL and/or consolidator CSC. In this way, in an iterative procedure, starting from arbitrary projections, higher quality projection directions can be obtained in one or more iterations the desired location may be computed P conclusively. The consolidator may implement a consensus prediction determination based on the back-projections such as the said projection lines or back-projected sets for the given projections more generally.

For example, in some embodiments a suitable projection geometry (e.g. for orthogonal projection—and angle) may be found in an optimization procedure, over one or more iterations. This procedure is configured to find the projection geometry that improves, for example minimizes, an average deviation from orthogonality between projection direction and inter-vertebral curve segment for each pair of subsequent vertebrae, as estimated up to this point in the localization process, e.g. from previous iterations of applying the projection-based localization.

It may be the case that data points in a projection do not coincide along different directions. For example, a mid-point of a vertebra body may be sufficient for localization, but not so border points of the vertebra body. In the latter case, shape primitive may be fit to estimate the location. For example, an ellipse/ellipsoid or other more realistic shape may be used as shape primitive to fine-tune the localization.

It will be understood that all manner of projection geometries are envisaged herein in including parallel projections (as shown in FIGS. 3,4) and divergent projections such as for virtual cone beams or fan, wedge beams etc. In case of divergent (central) projections, the line e in FIG. 3 (and back-projection lines m in FIG. 4) may relate to the main direction running from viewpoint to a central point on the projection surface, it being understood that that there are plural such projections for each point in the projection surface.

The projection surface may be outside volume or may intersect volume V to so define section(s) through the volume V. Preferably, the projection/back-projection line(s) lj, mj are chosen so as to pass through points in the topological interior of the volume V as it is locations of structures a within the volume (corresponding to ROIs within the patient) that are of main interest herein, as opposed to surface points of the volume which are disregarded herein and of no interest. Thus, the projector is configured to use topological interior points away from surface of volume V, and it is such interior points that are projected onto the projection surface to obtain the projection(s) π for the localizer component LC/machine learning model M to process. For present purposes, volume V may be taken conceptually as a topologically open so excludes its outer boundary surface embedded in 3D space ER. However, such surface points are not necessarily excluded and may be used in addition to one or more interior points.

The projection operation Π implemented by projector PR is to be construed broadly herein. It includes forward projection operations such as summation of voxel values inside volume V at position x along geometrically rays [symbol] ⱼ to collapse the voxel values into line integrals on the projection surface, thus implementing a mapping operation from 3D to 2D:

$$\prod : 3 D \to 2 D , π = \int V ( v + t \vec{ℓ} ) d t \qquad ( 1 )$$

t is a parameterization of the respective projection direction [symbol] (denoted in (1) more aptly as a vector in 3D) and v is the 3D location in or outside V of viewpoint. The integration over t terminates in points on projection surface. As mentioned, the projection surface is either inside/intersecting volume V, or is outside V and can be a plane which is preferred but may be instead for some viewpoint(s) a curved surface. As an extension, of (1), a weighted projection operation Π may be envisaged herein, with a real valued weight or transfer function w( ) defined in 3D space, in particular for points making up the volume.

$$\prod : 3 D \to 2 D , π = \int f ( V ( v + t \vec{ℓ} ) ) w ( v + t \vec{ℓ} ) dt \qquad ( 2 )$$

Thus, (2) implements a weight-modulated line integral projection. For example, w may be chosen as indicator function of an arbitrary section through volume V. The projection (2) may thus result in the said section through volume V. Any other function w may be used, other predefined or user defined. (1) is a special case of (2) when w is defined as the identity function w(x)=x for any point x in volume V. The weight function w may be dependent on the projection direction [symbol] . In addition or instead of the weight function w, a transfer function ƒ may be used. The transfer function may be used for example to transform gray values into other data values more appropriate for MRI for example. The transfer function may thus be imaging-modality dependent.

It will be understood herein that eqs (2) or (1) are not confined to projections from 3D to 2D although this example is mainly used herein for illustration and is indeed envisaged in some embodiments. Thus, (2), (1) may be extended for any weight and or transfer-function modulated projection from N-dimensional space to (N-k)-dimensional space, with N≥3 and k≥1, although k=1 is mainly envisaged herein. Whilst (1) and (2) are formulated for linear projections, the principles herein are not so confined and generalized in particular non-linear projection mappings Π are also envisage herein as explained below at (4).

As may be appreciated herein, system SYS may include, or may have access to, a bank of localizer components LCₖ, each including a respective model Mₖ. specially trained for a specific anatomy to be localized. However, a single model may still be used but this may need to be trained on a range of different anatomy features.

User interface UI may allow user to indicate a label, such as a name (spine, n-th vertebra, etc) for the structure of interest whose location P is sought. The system SYS maps this request to the correct model Mₖ in the bank and accesses the associated model Mₖ. Based on the anatomical knowledge for this structure and/or the imaging geometry used for generating the volume V, suitable projection directions, or projection geometries more generally, are selected by selector SL and are used to instruct the projector PR to compute the corresponding projection(s) π. The imaging geometry may be assumed to be associate with the volume V. A data structure may include information on the projection directions used for the measured raw projection data λ, and the coordinate system for the spacer ER in which volume V is embedded. The localizer LC may be triggered by some software or module, not necessarily directly by the user. For example, an atlas registration module or a planning application may request a localization for a certain structure a/related anatomy. The type of anatomy is requested, via a function call for example. The localizer then accesses the modern Mₖ trained for this type of anatomy, and processing commences to compute the location in the volume V. The type of anatomy may include multiple structures and require multiple models to run to localize all required structures.

In general, a given model Mₖ in the bank is trained for some specific localization task. Depending on how the task is formulated, different structures may be detected/focused on. For example, the model may be trained to detect landmark(s) on a given vertebra among other vertebrae. The model may be trained to detect some or all structures of a certain type. Any output of model M may be post-process to further tailor this to a specific task. For example, a segmentor may “count” the vertebrae structures to find L03, etc.

Localizer component LC may assign an anatomic label to indicate the anatomical names of the one or more structures found.

In order to better guide the system SYS, under interface UI may be configured to allow user to designate a rough estimate, as region in the volume V, where the structure of interest is assumed to be located.

The location P computed may be refined into a 3D segmentation that represents the 3D shape of the structure. A 3D shape model may be used for the structure of interest. The structure's location, such as a set of plural coordinates as provided by localizer LC may be fit by combiner/consolidator CSC in a separate optimization procedure to the best 3D shape model from a bank of shape models, or to the best portion of a global 3D shape model. A figure of merit may be used to measure the fit as express by a cost function

In general, the location P, in terms of plural coordinates, may define landmarks and or contours or object shapes. These can be further refined based on the original 3D data set V, for example based on grey values and edges in the volume. In other words, rather than using an external shape model, structure, textures etc in the volume itself is used in a optimization to fit the location information P by consolidator CSC or other post-processing component to the information in the volume at the location P. Model based segmentation may be use for example in which the location P coordinates are treated as the outer hull of a shape and this is being fit to structure in the volume defined by the location information.

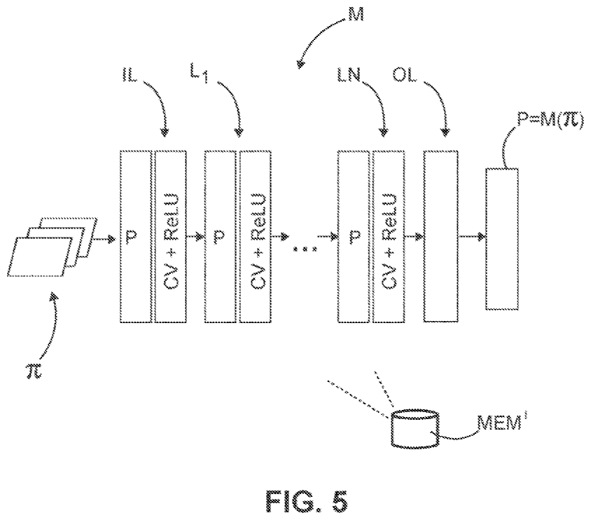

Reference is now made to the schematic block diagram of FIG. 5 which shows components of a machine learning model as envisaged herein in embodiments. Preferably, artificial neural network type models, or simply neural networks (“NN”) may be used, in particular of the convolutional type (“CNN”). CNNs have been found to work well processing spatially correlated data such as is image type data as processed herein.

CNNs use convolutional operators CV. The CNN, or NN model M more generally, is made up of a set of computational nodes arranged in cascading layers, with nodes in one layer passing their output as input to nodes in a follow up layer. The nodes in layers are shown schematically as blocks IL, Lj, OL.

In FIG. 5, projection imagery π provided by projector PR is input into model M. In response thereto, model M provides in the end-to-end embodiment output M(π)=P, the in-volume 3D location P(σ) or structure σ. In the indirect embodiment of FIG. 2B, the output M(π)=p(φ) (=p), the location in 2D of the structure σ's projection footprint.

The model network M may be said to have a deep architecture because it has more than one hidden layer. In a feed-forward network, the “depth” is the number of hidden layers between input layer IL and output layer OL, whilst in recurrent networks the depth is the number of hidden layers, times the number of passes.

The layers of the network, and indeed the input and output, and the input and output between hidden layers (referred to herein as feature maps), can be represented as two or higher dimensional matrices (“tensors”) for computational and memory allocation efficiency.

Preferably, the hidden layers include a sequence of convolutional layers, represented herein as layers L1-LN. The number of convolutional layers is at least one, but a plurality is preferred. The number of hidden layers may be in the two or even three digit figures, but less than that, in the 10s, is not excluded. Any types of layers can be used herein, as well as any number of input and output nodes. The number of nodes may in particular dependent on the size of the input, so as to allow the network to accept a single projection or plural projections at once for example.

In deployment, projection input data π is applied to input layer IL. The input data π then propagates through a sequence of hidden layers L1-LN (only two are shown, but there may be merely one or more than two), to then emerge at output layer OL as an estimate output M(π)=P or φ. In the FIG. 2A embodiment, the 3D location P un volume may be provided as one or more coordinates (such in a segmentation) or as a bbox [(a,b), w,h] or [(a,b,c], w, h, d], wherein (a,b) or (a,b,c) are coordinates in 2D or 3D, respectively, of a designated point of the bbox, such as lower left hand corner, etc. Coordinates w,h,d are width, height and depth, respectively. A location heatmap regression is also envisaged herein, on which more further below. The input data may include the contextual data c to form enriched input. The context data c may thus be co-processed by the model in addition with the projection input. In the embodiment of FIG. 2B embodiment, the output of M is the respective 2D location p in the respective projection π.

In embodiments, downstream of the sequence of convolutional layers, and upstream the output layer OL, there may be one or more fully connected layers (not shown), in particular if a regression result is sought. The output layer ensures that the output y has the correct size and/or dimension.

Preferably, some or all of the hidden layers are convolutional layers, that is, include one or more convolutional operators (or “filters”) CV which process an input feature map from an earlier layer into intermediate output, sometimes referred to as logits. An optional bias term may be applied by addition for example. An activation layer processes, in a non-linear manner, the logits into a next generation feature map which is then output and passed as input to the next layer, and so forth. The activation layer may be implemented as a rectified linear unit RELU as shown, or as a soft-max-function, a sigmoid-function, tan h-function or any other suitable non-linear function. Optionally, there may be other functional layers such as pooling layers PL or drop-out layers (not shown) to foster more robust learning. The pooling layers PL reduce dimension of output whilst drop-out layer sever connections between nodes from different layers.

In machine learning set-ups, a range of NNs models may be used, such as those with dimensional bottleneck structure. Examples include “U-net” networks where feature maps are dimensionally reduced with layer depth, down to a representation at lowest dimensional (“latent space”) at a given layer, and feature map dimension may then be increased again in downstream layers with dimension at output layer having the requited size to describe location P. U-net type networks were proposed by O Ronneberger et al in “U-Net: Convolutional Networks for Biomedical Image Segmentation”, available as preprint at arXiv:1505.04597 [cs.CV], submitted 18 May 2015. The NN networks may be feedforward or recurrent. Bounding box detection may be performed with e.g. single- or two-stage object detection approaches, such as Faster R-CNN (proposed by Ren et al in “Faster R-CNN: Towards Real-Time Object Detection with Region Proposal Networks”, IEEE Transactions on Pattern Analysis and Machine Intelligence, Volume: 39, Issue: 6, Jun. 1, 2017), or a YOLO setup as such proposed by Redmon et al in “You only look once: Unified real-time object detection”, IEEE Conference on Computer Vision and Pattern Recognition, pp. 779-788, June 2016). Other options include SSD as described by Liu et al in “SSD: Single shot multibox detector”, Computer Vision—ECCV 2016, pp. 21-37, Springer international Publishing, 2016), or EfficientDet as described by Tan et al in “EfficientDet: Scalable and Efficient Object Detection”, Proceedings of the IEEE/CVF Conference on Computer Vision and Pattern Recognition, 2020, pp. 10781-10790). The cited bbox-based CNN methods allow for accurate and relatively efficient localization of several-class objects with the same network, also enabling the usage of network states pre-trained on public object detection data sets as a starting point in the model training.

The ML model is not necessarily of the regressor type, but may be configured as a classifier instead. A binary classifier may be used, the two classes representing whether or not the structure σ is present in the input imagery. Class Activation maps (“CAM”) may be computed by locator component IC. The CAM may be rendered as a heatmap. The CAM or its heatmap may be mapped on the input or is back-projected into the volume V to identify the location. CAMs assigns scores to input voxel or pixels in relation to their contribution to the classification results. Gradient based methods may be used to compute CAMs. Thus, in this embodiment, the location is obtained by a combination of classification with CAMs used as an indicator for the in-volume location P. Score magnitude correlates with location, the region with high scores higher than a certain threshold may thus be taken as an indicator for location P.

GPU(s) (graphical processing unit) or other processor types capable of parallel computing such as those of multicore design may be used to implement the system SYS, in particular the trained model M/localizer component LC. Using such processor affords better real-time experience and high throughput. The system SYS may be used online, in quasi-real-time, during imaging sessions and/or interventions, but may be used instead offline, to analyse prior image volumes of prior session as may be accessed on medical databases, such as PACS (picture archiving and communication system) or other image repositories.

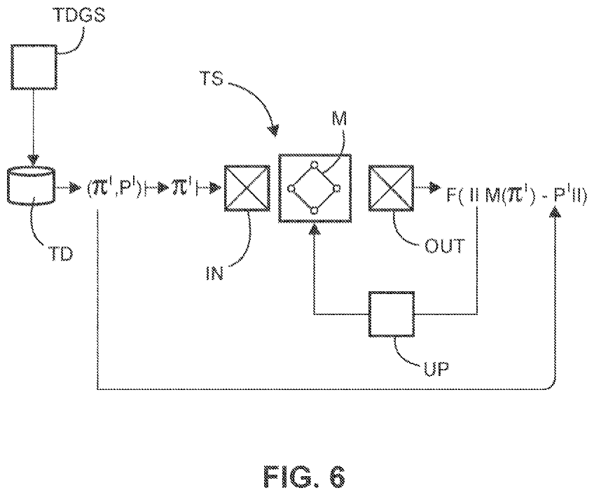

Reference is now made to FIG. 6 which shows a schematic block diagram of a training system TS for training a machine learning model M for use in localizer component LC.

Operation of the system is based on training data. In a supervised learning scheme, the training data comprises pairs (π′ₖ,P′ₖ)^{k} of training input π′ and its associated target or “label” P′. The prime “′” notation indicates herein training data as opposed to in-deployment data in unprimed notation as used hitherto above and below. The earlier mentioned enriched input may be written and supplied as (π′,c,P′), with c the respective contextual data such as patient bio-characteristics, etc The training data may be sourced from existing imagery held in medical databases TD for example. It is preferred herein that the training data is sourced from historical image volumes from patients across a broad demographics. The target P's may be searched from medical records or may be obtained by human expert annotation. In addition or instead of using such historical imagery suitably annotated/labelled, a training data generator system TDGS may be envisaged herein which allows synthesizing such suitably labelled training data to so enhance the variability of an existing stock of historical training data for example and to make sourcing of training data less cumbersome, in particular in relation to annotations which may be a laborious task. Data annotation/labelling may be done automatically, for example by registration to an anatomical atlas. There may be an optional functionality for user input for manual review/correction.

The original historical training data and/or the synthesized ones are processed, preferably in batches, in the training system to adjust parameters of a machine learning model.

The training data, either historical or synthesized, may be processed by data augmentation techniques to increase variation.

In ML, two phases may be distinguished: a training phase and subsequent deployment phase. In training phase, the model M is processing training data to adjust its parameters. After training phase, or a cycle thereof, the model may be made available for use in location determiner in clinical practice to help clinician find the structure of interest in a given patient image volume. In deployment, the model is processing new data, not from the training data set.

In more detail and referring again to the training phase, an architecture of machine learning model M, such as the CNN network shown n FIG. 5, is pre-populated with initial set of parameters. The parameters may θ include weights of the convolutional operators CV in case of a CNN. Other parameters may be called for in in other models. The parameters of model M represent a parameterization M^{θ}. It is an object of the training system TS to optimize, and hence adapt, the parameters θ based on the training data (π′ₖ,P′ₖ)^{k} pairs. In other words, the learning or training can be formulized mathematically as an optimization setup, where a cost function F is minimized, although the dual formulation of maximizing a utility function may be used instead.

Assuming for now the paradigm of a cost function F, this measures the aggregated residue(s), that is, the summed error incurred between data estimated by the model M and the targets as per some, or all, of the training data pairs k in a batch or over all training data:

$$arg min {}_{θ} F = {\sum }_{k} d [ {M}^{θ} ( {π}_{k}^{′} ) , {P}_{k}^{′} ] \qquad ( 3 )$$

In eq. (3), function M( ) denotes the result of the model M applied to training input π′ₖ. The result will differ in general from the associated target P. This difference, or the respective residuals for each training pair k, are measured by a distance measure d[,]. A suitable norm function of differences may used, d=∥M^{θ}(π′ₖ)−P′ₖ∥. Thus, the cost function F may be pixel/voxel-based, such as the L1 or L2-norm cost function, or any other norm Lp. The distance function may operate component-wise on coordinate components of the locations. Specifically, The Euclidean-type cost function in (3) (such as least squares or similar) may be used for the abovementioned regression task when output layer regresses into location P or p. When the model M is to act as classifier, for example in the CAM embodiment, the summation in (3) is formulated instead as one of cross-entropy or Kullback-Leibler divergence or similar.

The output training data M(π′ₖ) is an estimate for target P′ₖ associated with the applied input training image data π′ₖ. As mentioned, in general there is an error between this output M(π′ₖ) and the associated target P′ₖ for each pair k. An optimization procedure such as backward/forward propagation or other gradient based method may then be used to adapt the parameters θ of the model M so as to decrease the residue for the considered pair (π′ₖ₊₁, P′ₖ₊₁) or, preferably for a sum of residues in batch (a subset) of training pairs from the full training data set.

The optimization procedure may proceed iteratively. After one or more iterations in a first, inner, loop in which the parameters θ of the model are updated by updater UP for the current batch of pairs (π′ₖ,P′ₖ), the training system TS enters a second, an outer, loop where a next training data pair (π′ₖ₊₁, P′ₖ₊₁) or a next batch is processed accordingly. The structure of updater UP depends on the optimization procedure used. For example, the inner loop as administered by updater UP may be implemented by one or more forward and backward passes in a forward/backpropagation algorithm or other gradient based setup, based on the gradient of F. In general, the outer loop passes over batches (sets) of training data items. Each set (“batch”) comprising plural training data items and the summation in (3) extends over the whole respective batch, rather than iterating one by one through the training pairs, although this latter option is not excluded herein.

Optionally, one or more batch normalization operators (not shown) may be used. The batch normalization operators may be integrated into the model M, for example coupled to one or more of the convolutional operator CV in a layer. BN operators allow mitigating vanishing gradient effects, the gradual reduction of gradient magnitude in the repeated forward and backward passes experienced during gradient-based learning algorithms in the learning phase of the model M. The batch normalization operators BN may be used in training, but may also be used in deployment.

For the FIG. 2B embodiment, the training sets include (π′ₖ₊₁, p′ₖ₊₁), with p a location in 2D of the footprint of structure a in the projection π′ₖ₊₁, and in eq (3), 3D P′ₖ is substituted by p′ₖ.

The training system as shown in FIG. 5 can be used for all learning schemes, in particular supervised schemes. Unsupervised learning schemes may also be envisaged herein in alternative embodiments. GPU(s) may be used to implement the training system TS. The fully trained machine learning module M may be stored in one or more memories MEM′ or databases, and can be made available as trained machine learning models for use in system SYS.

The training image volumes V′ may stem from a different imaging modality than the one for which the ML model is intended. For example, projections across MRI volumes may be computed and the model M is trained based thereon, but the trained model M may then be used in deployment for localizing structures in CT or other X-ray image volumes. A transfer function ƒ may be used in the projection by training data generation system TDGS to make the projections look more X-ray like, for example. The transfer function may be imaging modality-dependent. In general, training data generation system TDGS may attempt to make data of, or derived from, different modalities (e.g. by projection) appear qualitatively similar. For example, an MRI image may be processed so that bone structures would be brighter than other tissues, thus making the images more similar to CT, etc. Sobel filtering or other types of filters may be used to mimic the response characteristics of the respective imaging modality. In in similar manner, model may be trained on X-ray volumes whilst it is MRI volumes that are encountered during deployment. Other modality combinations are also envisaged, including using several different modalities in both training and deployment scenarios.

In embodiments, the system TDGS process a given training volume for some patient, and use projector PR to compute for example at random, projection across the volume. Preferably the projection direction sample in good density a 3D unit sphere in which the volume can be thought to be embedded. This projection sampling may be repeated for multiple volumes from different patients. Because the projection operation is controlled, and the location of the structure of interest is per definition known, labelling is automatic. Multiple types of structures of interest can be processed this way. Alternatively, randomization is restricted to a range of projection views that are expected to be relevant in deployment. In this manner, synthesized training data can be generated.

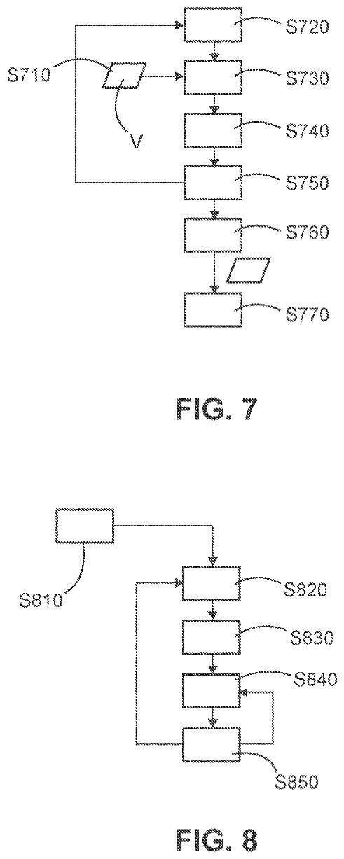

Reference is now made to FIG. 7 which shows a flow chart of an image-based method for localizing an (image) structure of interest in a high dimensional image volume. Image volume is at least 3D but may be higher, such as 4D or higher still. The structure may represent an anatomy or part thereof of any other region of interest ROI. The localization is indicated by one or more coordinates within the volume, a bbox or a segmentation map, as required.

The original input volume V is generated at step S710 such as by reconstruction from original projection raw data A acquired by a tomographic imaging apparatus of at least a part of a patient.

Random or pre-defined synthesized projection imagery π across the volume, or in respect of the volume V, is then computed in projection step S730 at different projection geometries using any suitable projection mapping, linear or not. For example, in a linear projection geometry, different projection directions are used. The Projection directions, or in general the projection geometry used in step S730, are/s, in general different from the imaging geometry used to acquire the original raw projection data λ from which volume V was reconstructed.

The projection geometry, such as the projection directions and/or other projection geometry parameters or aspects to compute the projections, may be pre-selected at step S720 based on prior anatomical knowledge or previously computed localization results, or indeed on user input. The selection of projection geometry settings, such as projection directions, may be dynamically adapted for example, based on the imaging modality or density of the initial scan. The projection may be based on previous iterations of predicted locations. A random projection geometry is used initially, and this is then refined in one or more iterations based on some objective, such as sufficient separation of in-projection structures footprints from surroundings.

The projection operation at step S730 results in a single, or preferably, multiple projection images π of the volume. The projection images include preferably projection footprints of the structure of interest in the volume.

At step S740 the one or more projection images are then processed by a trained machine learning module to produce a result. The result may include the location P in 3D, within the volume V, of the structure of interest σ. The result may be output at step S760.

Instead, the machine learning based result obtained at step S740 is an intermediate result. The intermediate result may represent one or more locations p in the projection imagery indicating, in 2D, the respective location of respective 2D projection footprint of the structure of interest.

The processing S740 may then include a further processing step to use the so localized 2D information to compute the 3D location which may then be output at step S760. Specifically, the processing at step S740 may include processing by back projecting the projection footprint locations into 3D by casting respective lines through the image domain in which the image volume is located. However, more general projection geometries are used in which case the back-projected sets are more general than lines, so may include curved lines or surfaces or sub-volumes for example.

The lines so passed, or more generally the subsets defined by back-projection, may be combined in processing step S740 such as by consolidation, combination, triangulation, averaging or otherwise to obtain the final output P at step S760.

A consistency check may be performed at step S750 and the initially selected projection directions are adjusted if there is an inconsistency found such as no intersection of the back projected lines or other sets. Another quality parameter evaluation at step S750 is also envisaged herein.

A single projection may be used, in particular in conjunction with contextual information c of the patient, such as height, size, BMI, sex etc. This may allow the machine learning module to use surrounding information in conjunction with the context data to correctly estimate, extrapolate, the 3D location of the structure of interest within initial image volume V. For example, inter-structure distance of structures surrounding the structure of interest and the structure of interest in the projection imagery may be taken into account to estimate correct scaling factor(s) to estimate into 3D domain the correct location of the structure of interest.

Preferably, however, plural projection images are obtained along different projection directions or, more generally, at different projection geometries as explained above.

At optional step S770 the output location P may be (further) processed. The processing may include displaying the location, either on its own or in conjunction (such as a graphical overlay) with some or part of the image data, that is, the projection image(s) or the volume V. In addition or instead, the location may be stored or used to control a medical device. A suitable control interface may be used for this. In some embodiments the estimated location P may be used in a radiation treatment plan algorithm to define organ(s) at risk and/or a target volume.

Generally, the projection operation S740 allows extracting information and projecting same on to a lower dimensional representation. This lower dimensional representation may be useful as it allows reducing by order of magnitude the memory requirements and the CPU load on the machine that is to implement the machine learning model computations. Also, the training procedure, which sometimes requires multiple passes of forward/backward propagations in NN models for example, may be done more efficiently in terms of memory and computation time at higher throughput. The latter may be welcome if training is not a one-off, but the model M is re-trained in light of new training data in repeated training cycles.

Reference is now made to FIG. 8 which shows a flow chart of a method for training the machine learning model to estimate the 3D location of a structure of interest.

At optional step S810, synthesized training data is generated based on historical image volume data. An initio training data synthesis is also envisaged herein, such as by using generative type ML models, such as generative adversarial networks (“GAN”) or similar. The above described training system TS with projection sampling at different projection geometries may be used for this step for a known 3D location of known structure of interest. This results in automatically labelled projection data, either with location P in 3D or location p in 2D, according to embodiments FIGS. 2A, B, respectively.

At step S820 training data is received.

Broadly, based on the training data. parameters of the model are adapted. This adaptation may be done in an iterative optimization procedure. The procedure is driven by a cost function. Once a stopping condition is fulfilled, the model is considered trained.

In more detail, and with particular reference to a supervised training setup, at step S820, the training inputs π′ₖ in the current batch are applied to a machine learning model M having current parameters 9 to produce a training outputs M(π′ₖ).

A deviation, or residue, of the training output M(π′ₖ) from the respective associated target P′ₖ is quantified at S830 by a cost function F. One or more parameters of the model are adapted at step S840 in one or more iterations in an inner loop to improve the cost function. For instance, the model parameters are adapted to decrease residues as measured by the cost function. The parameters may include in particular weights of the convolutional operators CV, in case a convolutional NN model M is used. M(π′ₖ) is either P′ in 3D or location p′ of the footprint in the projection image π′ₖ

At step S850 a stopping condition is evaluated. If this is fulfilled, the training method then returns in an outer loop to step S810 where the next batch of training data is fed in. If the stopping condition is not fulfilled, method flow returns to parameter adaptation at step S840.

In step S840, the parameters of the model are adapted so that the aggregated residues, considered over the current and preferably over some or all previous batches are decreased, in particular minimized.

The cost function quantifies the aggregated residues. Forward-backward propagation or similar gradient-based techniques may be used in the inner loop. A dual formulation in terms of a maximization of a utility function is also envisaged.

Examples for gradient-based optimizations may include gradient descent, stochastic gradient. conjugate gradients, Maximum likelihood methods, EM-maximization, Gauss-Newton, and others. Approaches other than gradient-based ones are also envisaged, such as Nelder-Mead, Bayesian optimization, simulated annealing, genetic algorithms. Monte-Carlo methods, and others still.

It will be understood that the principles disclosed herein are readily extended to image volumes of any dimension N, with projection into an N−1 dimensional space. For example, localization in 4D can be reduced to 3D. etc. Iterative, recursive processing of N dimensional volumes can be reduced down to 2D or, optionally, even down to 1D processing if required.

Whilst in the above embodiments, main reference was made to projection directions, it will be understood that such projection directions or lines are merely one example of a projection geometry setting for computing the projections. Instead of changing projection directions, a distance between viewpoint and projection plane may be adapted instead or in addition. For other than CT modalities, the projection geometry may relate to other settings, such as LOR orientation or acceptance angles and/or detector configuration in nuclear imaging, or different coil responses or pulse sequences, etc,

Also, whilst the above, in particular eqs (1), (2), is formulated mainly in terms of linear projections such as orthogonal or central projections along projection directions (lines), the above-described principles are of equal application to non-linear projections. Non-linear projections may be defined herein as a generalized projection mapping Π:

$$\prod : {ℝ}^{N} \to {ℝ}^{N - K} : ⊓ ( v ) = x ∈ π ⊂ {ℝ}^{N - k} , v ∈ V ⊂ {ℝ}^{N} \qquad ( 4 )$$

wherein the mapping n is continuous, so respects the spatial information in the higher dimensional volume V∈ [symbol] ^{N}.

Optionally, but not necessarily, n may be idempotent Π²=Π in respect of functional composition. In addition, generalized projection mapping Π defines, for each data point x in the projection π, the above-mentioned subset Π⁻¹(x) in the Volume V, which is preferably a proper subset in the volume V, and wherein the mapping 11 prescribes how each voxel in V contributes (if at all) to a given data point x in the projection π. The above-mentioned subset Π⁻¹(x) may be referred to herein as the generalized back-projection for a given projection n. The collection of all Π⁻¹(x) defines the back-projector BP in the general sense for non-linear projection mappings envisaged herein. This more generalized configuration of projections may be implemented for example as a setup for MRI imaging or other imaging modalities that do not necessarily follow the linear projection paradigm based on lines. Voxels are understood herein as data/image points in the higher N≥3 dimensional volume.

Components of the system SYS may be implemented as one or more software modules, run on one or more general-purpose processing units such as associated with the imaging apparatus IA, or on one or more server computers associated with a single imaging apparatus or with a group of imaging apparatuses.

Alternatively, some or all components of the system SYS may be arranged in hardware such as a suitably programmed microcontroller or microprocessor, such an FPGA (field-programmable-gate-array) or as a hardwired IC chip, an application specific integrated circuitry (ASIC). In a further embodiment still, the system SYS may be implemented in both, partly in software and partly in hardware. The system SYS may be integrated into the imaging apparatus IA or into a computer associated with the imager.

Different components of the system SYS may be implemented on a single data processing unit. Alternatively, some or more components of system are implemented on multiple processing units PU, possibly remotely arranged in a distributed architecture and at least some of which are connectable in a suitable communication network such as in a cloud setting or client-server setup, etc. The reconstructor RECON and/or the projector PR may be implemented remotely from the localizer component LC for example.

One or more features described herein can be configured or implemented as or with circuitry encoded within a computer-readable medium, and/or combinations thereof. Circuitry may include discrete and/or integrated circuitry, a system-on-a-chip (SOC), and combinations thereof, a machine, a computer system, a processor and memory, a computer program.

It should be noted that embodiments of the invention are described with reference to different subject matters. In particular, some embodiments are described with reference to method type claims whereas other embodiments are described with reference to the device type claims. However, a person skilled in the art will gather from the above description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not limiting. The invention is not limited to the disclosed embodiments. Other variations of the disclosed embodiments can be understood and effected by those skilled in the art in practicing the claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims, be they numerical, alphanumerical, or a combination of one or more letters, should not be construed as limiting the scope.

1. A computer-implemented medical image processing method, comprising:
receiving input data comprising at least one projection of an at least three-dimensional, 3D, image volume generated by a medical imaging apparatus;
processing the input data by using at least a trained machine learning model to at least facilitate computing a location in the 3D volume of a structure of interest; and
outputting output data indicative of the said location.

2. The method according to claim 1, wherein the input data includes plural such projections at different projection geometries and the said processing includes back-projecting projection footprints of the structure, or respective locations thereof, in the plural projections as computed by the trained machine learning model.

3. The method according to claim 1, wherein the processing includes combining locations of the said-projection footprints into the location.

4. The method according to claim 1, further including providing the output data for additional processing, the additional processing including at least one of: i) registering the 3D volume, or at least a part thereof, on an atlas based on the output data, ii) displaying the output data on a display device, iii) storing the output data in a memory, iv) processing the output data in a radiation therapy system, v) controlling a medical device based on the output data.

5. The method according to claim 1, further including selecting at least one of the at least one plural projection based on one of: i) earlier one or more projections processed by the machine learning model and ii) the projection geometry for at least one of the received projections based on the structure of interest.

6. The method according to claim 1, wherein the different projection geometries includes different projection directions.

7. The method of claim 1, wherein the model includes an artificial neural network model.

8. The method according to claim 1, wherein the structure of interest is at least a part of a mammal spine.

9. The method according to claim 1, wherein the medical imaging apparatus is of the tomographic type.

10. The method according to claim 1, wherein the imaging apparatus is any one of i) an X-ray based computed tomography, CT, scanner and ii) a magnetic resonance imaging apparatus.

11. A method of training, based on training data, a machine learning model for facilitating computing, based on input data, a location in an at least 3D volume of a structure of interest, the input data comprising at least one projection at across or into an at least 3D image volume.

12. (canceled)

13. A non-transitory computer readable medium comprising instructions which, when running on at least one processor, causes the at least one processor to:
receive input data comprising at least one projection of an at least three-dimensional, 3D, image volume generated by a medical imaging apparatus;
process the input data by using at least a trained machine learning model to at least facilitate computing a location in the 3D volume of a structure of interest; and
output output-data indicative of the location.

14. A medical image processing system, configured to:
receive input data comprising at least one projection of an at least 3D image volume generated by a medical imaging apparatus;
process the input data by using at least a trained machine learning model (to at least facilitate computing a location in the 3D volume of a structure of interest; and
output output-data indicative of the said location; and
any one of: i) a medical imaging apparatus for generating the at least 3D volume, ii) a medical device controllable by the output data.

15. (canceled)

16. A training system configured to train, based on training data, a machine learning model for facilitating computing, based on input data, a location in an at least 3D volume of a structure of interest, the input data comprising at least one projection at across or into an at least 3D image volume.

17. (canceled)
